(19) United States
(12) Patent Application Publication
(10) Pub. No.: US 2019/0295762 A1
(43) Pub. Date: Sep. 26, 2019

(54) THREE-DIMENSIONAL WOUND CORE OF TRANSFORMER WITH ISOSCELES TRIANGULAR IRON YOKES

(71) Applicant: HAIHONG ELECTRIC CO.,LTD., Kaiping (CN)

(72) Inventors: Kaixuan XU, Kaiping (CN); Lizhen ZHAI, Kaiping (CN); Qingning LIANG, Kaiping (CN); Jingtao LUO, Kaiping (CN); Libo ZHOU, Kaiping (CN)

(21) Appl. No.: 16/439,271

(22) Filed: Jun. 12, 2019

Related U.S. Application Data
(63) Continuation of application No. PCT/CN2017/112730, filed on Nov. 24, 2017.

(30) Foreign Application Priority Data
Mar. 10, 2017 (CN) 201720238214.1

(51) Int. Cl. H01F 27/26; H01F 27/245; H01F 27/25

(52) U.S. Cl. CPC H01F 27/26; H01F 27/25; H01F 27/245

(57) ABSTRACT

A stereoscopic transformer wound core having isosceles triangle yokes is provided, comprising three core limbs and six yokes. The three core limbs and the six yokes are formed by the assembly of three rectangular single frames. The sizes and shapes of two of the rectangular single frames are completely identical, and the length of the yoke of the remaining rectangular single frame is greater than that of the yokes of the other two rectangular single frames, the three rectangular single frames have an equal height, two adjacent rectangular single frames are assembled to form core limbs with the cross section being a polygon externally connected to a whole circle. The stereoscopic transformer wound core can decrease the transformer transportation width, lower the transportation difficulty, reduce costs, and provide the shortest path for tapping a coil to a tapping switch through a lead, thereby greatly simplifying the lead arrangement.

### CROSS REFERENCE TO RELATED APPLICATIONS

This application is a continuation of International Application No. PCT/CN2017/112730, filed on Nov. 24, 2017, which takes priority from Chinese Patent Application No. 201720238214.1, filed on Mar. 10, 2017, the contents of each of which are incorporated by reference herein.

### TECHNICAL FIELD

The disclosure relates to a three-dimensional wound core of a transformer with isosceles triangular iron yokes.

### BACKGROUND

At present, advantages of a transformer product with a three-dimensional wound core, comprising symmetrical three-phase magnetic circuit, small reluctance, low excitation current, no-load loss and low noise, have been recognized by the power industry, and the product market share is continuously increasing. However, due to problems of a traditional transformer with a three-dimensional wound core, comprising small space at a junction of three-phase windings, complicated winding and body pressing processes, difficult connection of leads, and excessive transportation width of a transformer, the development of the product has been restricted for a long time.

### SUMMARY

In order to overcome the defects of the prior art, the disclosure is intended to provide a three-dimensional wound core of a transformer with isosceles triangular iron yokes, so that the advantages of the product are further improved.

The technical solution used to solve the technical problems in the disclosure is as follows.

A three-dimensional wound core of a transformer with isosceles triangular iron yokes comprises three core legs and six iron yokes, wherein the three core legs and the six iron yokes are spliced by three rectangular single frames, sizes and shapes of two of the rectangular single frames are completely identical, a length of the iron yoke of the remaining rectangular single frame is greater than that of the iron yokes of the other two rectangular single frames, the three rectangular single frames have an equal height, and two adjacent rectangular single frames are spliced into the core leg with a cross-section being a polygon externally connected to a whole circle.

Further, a surface of each rectangular single frame is coated with a solidified material.

Further, fishpaper is arranged between adjacent rectangular single frames to insulate the rectangular single frames from each other.

Further, the rectangular single frame is continuously wound by a plurality of whole silicon steel sheets or amorphous alloy strips.

Further, the iron yoke is bound with a heat-shrinkable band.

Further, the core leg is bound with a heat-shrinkable band.

The disclosure has the beneficial effects that: the three-dimensional wound core of a transformer with isosceles triangular iron yokes used in the disclosure has more operation spaces during winding, and the manufacturability and the working efficiency are obviously improved; a transportation width of the transformer is reduced, the transportation difficulty is decreased, and the cost is saved; a shortest path is arranged for tapping a lead of a winding to a tap switch, thus greatly simplifying the lead arrangement, and a length of the lead can be shortened by 50% to 60% compared with a transformer with the same structure using a three-dimensional wound core with an old structure, and meanwhile, an insulation space reserved for the passage of the lead is reduced, thus further reducing an overall external dimension of the transformer and the cost of the transformer.

### BRIEF DESCRIPTION OF THE DRAWINGS

FIG. 1 is a front view of the disclosure; and

FIG. 2 is a top view of the disclosure.

### DETAILED DESCRIPTION

The disclosure is further described below with reference to the drawings and the embodiments.

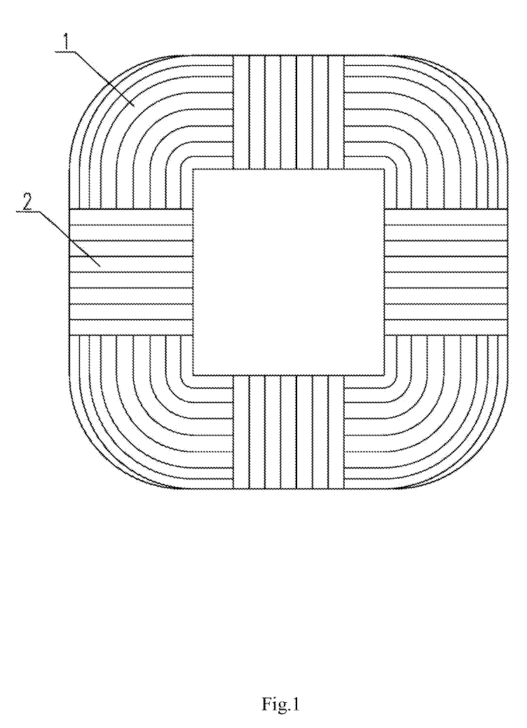

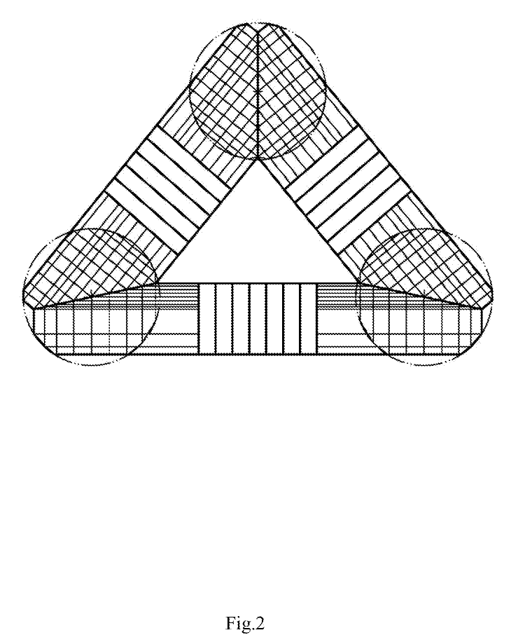

As shown in FIG. 1 and FIG. 2, a three-dimensional wound core of a transformer with isosceles triangular iron yokes according to the disclosure comprises three core legs and six iron yokes, wherein the three core legs and the six iron yokes are spliced by three rectangular single frames 1, sizes and shapes of two of the rectangular single frames 1 are completely identical, a length of the iron yoke of the remaining rectangular single frame 1 is greater than that of the iron yokes of the other two rectangular single frames 1, the three rectangular single frames 1 have an equal height, and two adjacent rectangular single frames 1 are spliced into the core leg with a cross-section being a polygon externally connected to a whole circle.

The rectangular single frame 1 is continuously wound by a plurality of whole silicon steel sheets or amorphous alloy strips. A surface of each rectangular single frame 1 is coated with a solidified material to enhance a strength of the core and an anti-corrosion function, which can be used for oil-immersed transformer and dry-type transformer. Fishpaper is arranged between adjacent rectangular single frames 1 to insulate the rectangular single frames from each other. The core leg is bound with a heat-shrinkable band 2 to bind the adjacent rectangular single frames together.

Each iron yoke is bound with a heat-shrinkable band 2.

The three-dimensional wound core of a transformer with isosceles triangular iron yokes used in the disclosure has more operation spaces during winding, and the manufacturability and the working efficiency are obviously improved; a transportation width of the transformer is reduced, the transportation difficulty is decreased, and the cost is saved; a shortest path is arranged for tapping a lead of a winding to a tap switch, thus greatly simplifying the lead arrangement, and a length of the lead can be shortened by 50% to 60% compared with a transformer with the same structure using a three-dimensional wound core with an old structure, and meanwhile, an insulation space reserved for the passage of the lead is reduced, thus further reducing an overall external dimension of the transformer and the cost of the transformer.

Certainly, the description above does not limit the disclosure, and the disclosure is not limited to the embodiments above. Any changes, modifications, additions or substitutions made by those skilled in the art within a substantial scope of the disclosure shall also fall within the protection scope of the disclosure.

What is claimed is:

1. A three-dimensional wound core of a transformer with isosceles triangular iron yokes, comprising:
three core legs; and
six iron yokes, the three core legs and the six iron yokes are spliced by three rectangular single frames, sizes and shapes of two of the rectangular single frames are completely identical, a length of the iron yoke of the remaining rectangular single frame is greater than that of the iron yokes of the other two rectangular single frames, the three rectangular single frames have an equal height, and two adjacent rectangular single frames are spliced into the core leg with a cross-section being a polygon externally connected to a whole circle.

2. The three-dimensional wound core of a transformer with isosceles triangular iron yokes of claim 1, wherein a surface of each rectangular single frame is coated with a solidified material.

3. The three-dimensional wound core of a transformer with isosceles triangular iron yokes of claim 1, wherein fishpaper is arranged between adjacent rectangular single frames to insulate the rectangular single frames from each other.

4. The three-dimensional wound core of a transformer with isosceles triangular iron yokes of claim 1, wherein the rectangular single frame is continuously wound by a plurality of whole silicon steel sheets or amorphous alloy strips.

5. The three-dimensional wound core of a transformer with isosceles triangular iron yokes of claim 1, wherein the iron yoke is bound with a heat-shrinkable band.

6. The three-dimensional wound core of a transformer with isosceles triangular iron yokes of claim 1, wherein the core leg is bound with a heat-shrinkable band.
